(19) United States
(12) Patent Application Publication
(10) Pub. No.: US 2012/0043026 A1
(43) Pub. Date: Feb. 23, 2012

(54) FILM PEELING METHOD

(75) Inventors: Michael Tillmann, Wurselen (DE); Helmut Tönnes, Duren (DE)

(73) Assignee: FECKEN-KIRFEL GMBH & CO. KG, Aachen (DE)

(21) Appl. No.: 13/266,044

(22) PCT Filed: May 6, 2010
(86) PCT No.: PCT/EP2010/056201

§ 371 Date: Oct. 24, 2011

(30) Foreign Application Priority Data
May 9, 2009 (DE) 10 2009 020 621.3

(51) Int. Cl. B32B 38/10

(52) U.S. Cl. 156/701

(57) ABSTRACT

The method provides that, in an initial peeling phase (AP), the material block is started to be peeled in a spiral shape. This is followed by a transition phase (UP) of a fraction of a turn so as to change to the set layer thickness. In the subsequent peeling phase (SP), the work is done with the same spiral pitch as in the initial peeling phase. During each turn of the material block, the knife is sunk further into the material block within a limited angular range and thereafter the turn is completed with the pitch of the initial peeling phase. Advantages are achieved by the fact that the set layer thickness is reached within fractions of a turn. The method can be executed with little expenditure of time and little waste of material.

The invention refers to a method for peeling a film off from a material block as the block is rotated about an axis, and in particular for peeling a foam material film.

DE 10 2006 027 271 B4 describes a method for starting-up a device for peeling a film from a material block. In this method, the material block is rotated round an axis, while a knife bar is continuously adjusted such that it performs a spiral movement with respect to the material block with the distance from the axis becoming ever smaller. In an initial peeling phase, the knife is moved into the material block while the material block is rotating, so as to prepare the surface of the material block for the subsequent peeling operation. Thereafter, he set thickness of the film is adjusted by means of an adjusting device and the material block is rotated by a maximum of one turn in which the set measure of the film is obtained. Eventually, the material peeled off so far is severed by a cut along the transverse direction of the film. In this method, the film thickness to be achieved is determined by the pitch of the spiral that is set in the peeling phase.

A phenomenon occurring when peeling films is that during a transition from a small to a larger layer thickness the subsequent layer will always be too thick. On the other hand, the subsequent layer will always be too thin when a change is made from a thicker to a thinner layer. This phenomenon can be attributed to the compressibility of the foam material and its restoring behavior. As a result, the set layer thickness is achieved only after a greater length of film has been peeled off.

It is an object of the invention to provide a film peeling method in which a minimum amount of material is lost when the layer thickness is changed.

The method according to the invention is defined by claim 1. It comprises the following steps:
performing an initial peeling phase for forming a spiral-shaped surface of the material block, whose radius decreases as the angle of rotation increases.
performing a transition phase in an angular range of less than 360° with a changed spiral pitch until the set layer thickness is reached,
performing a peeling phase with a spiral pitch corresponding to that existing in the initial peeling phase, wherein the spiral pitch of the transition phase is set for every time the knife passes through the angular range of the transition phase on the material block.

The method according to the invention provides that a transition step is performed during each turn of the material block, in which step the knife is moved a little closer to the axis so that the diameter of the helix is reduced in a step-like manner. The transition step extends over a fraction of a turn, for instance a quarter turn, i.e. 90°. The thickness of the layer formed is determined by spiral pitch in the transition range, wherein the spiral pitch is the feed of the knife directed towards the axis of the block per turn of the block.

In the method of the present invention, the same spiral pitch is used in the peeling phase as in the initial peeling phase. Therefore, the usually observable effect of an inexact layer thickness after a change of the adjustment does not occur, with the result that less waste is produced and the method o the invention has a better efficiency. Whereas in the known method the spiral pitch determines the layer thickness, the method of the invention provides that the layer thickness does not depend on the spiral pitch. The spiral pitch may even be reduced to 0, in which case peeling is performed “without a pitch outside the transition range”.

The angular range of the transition phase preferably is at least 20°, in particular at least 45°, of a turn. In the interest of avoiding too steep a spiral pitch during the transition phase, the transition phase should not be chosen too short. The upper limit of the transition phase is at approximately 180°. A transition phase of approximately 90° is preferred.

The method according to the invention is also suitable for peeling two different set layer thicknesses from the same material block, without having to stop the same. To this effect it is provided that a first peeling phase with a first set layer thickness is followed by a transition phase leading to a second peeling phase with a second set layer thickness. Here, the only material to be discarded is the material produced in the transition phase where the layer thickness changes and thus does not correspond to the set layer thickness.

A full and enabling disclosure of the present invention including the best mode thereof, enabling one of ordinary skill in the art to carry out the invention, is set forth in greater detail in the following description, including reference to the accompanying drawing in which

FIG. 1 is a schematic illustration of the peeling operation,

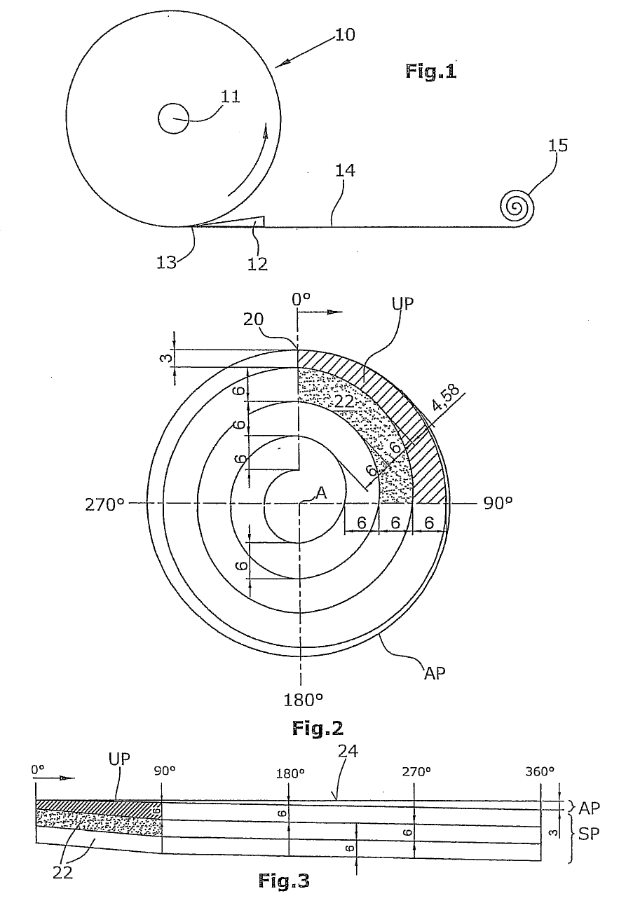

FIG. 2 is an illustration of the spiral-shaped trajectory the knife follows with respect to the axis of the material block,

FIG. 3 shows a development drawing of the spiral-shaped trajectory with the individual turns being shown one below the other,

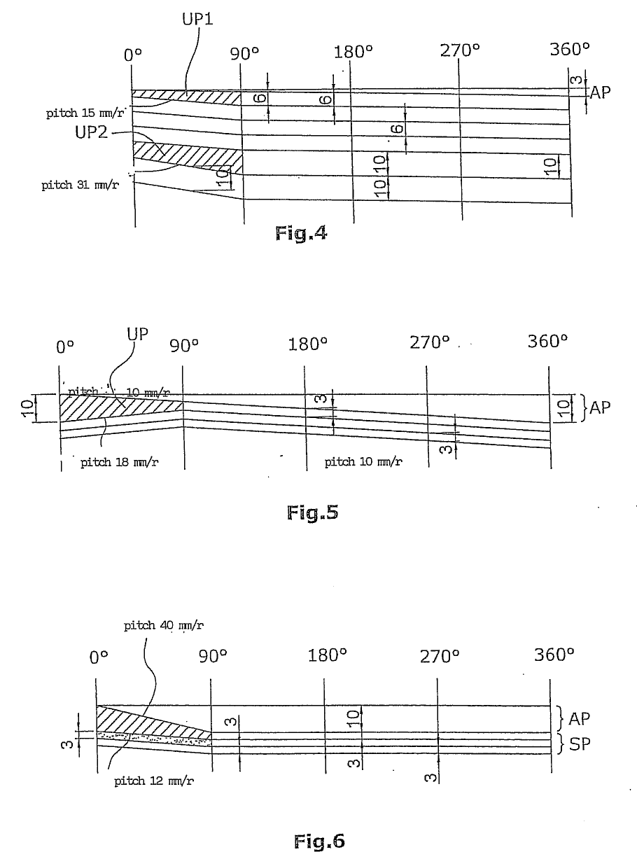

FIG. 4 shows a development drawing of the spiral-shaped trajectory in a method, in which a succession of different material thicknesses is produced,

FIG. 5 illustrates an example with a very large peeling angle for a time-saving removal of a large amount of material during initial peeling, and

FIG. 6 illustrates an embodiment of the peeling without a pitch in the transition range.

FIG. 1 illustrates a material block 10 of foamed material that is to be processed into a foamed material film. The material block 10 is generally cylindrical. It sits on a shaft 11 passed through the material block along the axis. A knife 12 is set against the material block, which knife is arranged on an adjustable knife bar in an approximately tangential orientation with respect to the material block and has a knife edge 13. The knife may be an endless knife belt. The knife's position with respect to the material block 10 is controlled by a control device such that, during the rotation of the material block 10, the knife is moved radially towards the axis A at a constant speed, so that the knife can follow a substantially spiral-shaped trajectory with respect to the axis of the material block. The knife peels a film 14 from the material block which is wound to a roll 15. The drawing device makes sure that the film 14 is moved at a constant transport speed, i.e. at a speed that is independent from the varying diameter of the material block.

FIG. 2 is a side elevational view of the material block 10 illustrating the trajectory along which the edge 13 of the knife travels. The proportions in the drawing are distorted because the layer thickness has been drawn to an exaggerated scale for reasons of clarity.

The beginning of the transition phase UP has been selected as the reference angle of 0°, which at the same time is the starting angle of the initial peeling phase AP.

The knife is set to the material block at the starting point 20 and is subsequently moved towards the axis A at a constant speed while the material block rotates. The initially cylindrical material block is cut in a spiral shape during the initial peeling phase AP. In the present embodiment, the spiral pitch is 3 mm/r during the initial peeling phase. After one full turn, the penetration depth of the knife into the material block is thus 3 mm. The initial peeling phase lasts for one full turn, i.e. 360°. Thereafter, the transition range UP starts, in which the spiral pitch is adjusted such that the set layer thickness is achieved at the end of the transition phase, in this case: 6 mm.

For the transition phase, the spiral pitch φ is set to

φ=(Δ·A)+a

### Here

φ is the spiral pitch in the transition phase,
a is the spiral pitch in the initial peeling phase,
b is the spiral pitch with which the set layer thickness would be reached in a uniform peeling operation,
Δis the difference b−a,
A is the quotient 360° divided by the angular range of the transition phase.

Thus, in the present embodiment, the equation yields a spiral pitch φ of

((6 mm/r−3 mm/r)·4)+3 mm/r=15 mm/r

in the transition phase UP. When the layer thickness of b=6 mm is reached at 90°, work is carried on with the same spiral pitch as in the initial peeling phase AP so that parallel cutting lines are obtained up to the end of the turn. This is followed by a transition zone 22 of 90° in which the spiral pitch cp is adjusted to the same value as in the transition phase UP, that is 15 mm/r in the present instance. The layer thickness is still 6 mm. In the first quadrant from 0°-90°, the spiral pitch is 15 mm/r, and the spiral pitch is 3 mm/r in the other three quadrants.

FIG. 3 illustrates a linear development of the trajectories. Line 24 identifies the original circumference of the cylindrical block. This is followed by the initial peeling phase AP with one full turn. Following the same is the transition phase UP and finally the material thickness is maintained constantly at 6 mm in the present case. The working process is carried out as a kind of step function with a transition range 22 of 90° being formed during each turn, in which the penetration depth of the knife into the material block is increased more than in the other zones.

During the peeling, and after the initial peeling phase AP has passed, the material peeled up to that moment can be cut off and discarded immediately after the start of the transition phase UP.

Tests have shown that the layer thicknesses measured correspond to the desired values in all angular ranges. In particular, no deviation has been found between the normal range and the transition range.

FIG. 4 illustrates an example with two transition phases UP1 and UP2, in which a transition to another layer thickness is effected, respectively. The first transition phase UP1 is followed by a plurality of turns with a layer thickness of 6 mm. This is followed by a transition to 10 mm. The pertinent spiral pitch φ2 is calculated in the transition phase UP2 as

φ2=(Δ·4)+a=((10 mm/r−3 mm/r)·4)+3 mm/r=31 mm/r.

A layer thickness that has to be discarded is produced only in the transition phase UP2.

FIG. 5 illustrates an example for a transition from a large layer thickness to a lesser one. In the initial peeling phase AP, he work is done with a spiral pitch φ of 10 mm/r so as to remove as much material from the material block as possible and to “clean” the same quickly. In doing so, a film thickness is achieved through one turn that eventually assumes a value of 10 mm. The layer thickness b to be achieved is 3 mm. The spiral pitch φ in the transition range UP is adjusted to

$$\begin{matrix}ϕ = ( Δ \cdot 4 ) + a \\ = ( ( 3 mm \text{/} r - 10 mm \text{/} r ) \cdot 4 ) + 10 mm \text{/} r \\ = ( - 7 mm \text{/} r \cdot 4 ) + 10 mm \text{/} r \\ = - 18 mm \text{/} r\end{matrix}$$

This is the pitch of the lower line of the transition phase UP. The initial peeling angle is negative. The material block moves away from the knife bar. At 90°, the initial pitch of 10 mm is set again, and peeling is done with that value for the next 270°.

FIG. 6 illustrates a “peeling without pitch outside the transition range”. In the initial peeling phase, the knife penetrates quickly into the material block during the first quadrant (0°-90°), whereafter the process is carried on with a pitch of 0,whereby a cylindrical cut is made. The spiral pitch in the transition phase UP is

$$\begin{matrix}ϕ = ( Δ \cdot 4 ) + a \\ = ( ( 3 mm \text{/} r - 0 mm \text{/} r ) \cdot 4 ) + 0 mm \text{/} r \\ = ( 3 mm \text{/} r \cdot 4 ) + 0 mm \text{/} r \\ = 12 mm \text{/} r\end{matrix}$$

Thus, the desired layer thickness of 3 mm is achieved in the peeling phase SP.

The method is executed using a peeling machine with electronic layer thickness adjustment through high-dynamic servo drives and an intelligent control means. The advantages of the method are as follows:
the desired layer thickness is reached within fractions of a turn in the angular range of the transition phase UP,
suitable for applications in which the set layer thickness is intended to vary in the course of the operation,
optimum use of material, since the next layer is not deformed by the previous cut,
change of layer thickness is always effected in the same angular range; thereby, the layer thickness is always reached precisely at any position.

1. A method for peeling a film from a material block while the block is rotated about an axis, using a control means that displaces a knife such that it follows a spiral-shaped trajectory with respect to the material block, said trajectory forming a spiral pitch defined by the feed of the knife per turn of the block, said method comprising the following steps:
performing an initial peeling phase for forming a spiral-shaped surface of the material block, whose radius decreases as the angle of rotation increases,
performing a transition phase in an angular range of less than 360° with a changed spiral pitch until a set layer thickness is reached,
performing a peeling phase with a spiral pitch corresponding to a pitch of the initial peeling phase, the spiral pitch of the transition phase being set each time the knife passes through the angular range of the transition phase on the material block.

2. The method of claim 1, wherein the spiral pitch for the transition phase is set to
φ=(Δ·A)+a
where a is the spiral pitch in the initial peeling phase, b is the spiral pitch with which the set layer thickness would be reached in a uniform peeling operation, Δ is the difference b−a, and A is the quotient 360° divided by the angular range of the transition phase.

3. The method of claim 1, wherein the angular range of the transition phase is at least 20°, preferably at least 45°.

4. The method of claim 1, wherein that the angular range of the transition phase is less than 180°, preferably 90°.

5. The method of claim 1, wherein the initial peeling phase covers an angular range of exactly one turn or more.

6. The method of claim 1, wherein a first peeling phase with a first set layer thickness is followed by a transition range that leads to a second peeling phase with a second set layer thickness.
